(19) United States
(12) Patent Application Publication
(10) Pub. No.: US 2005/0129936 A1
(43) Pub. Date: Jun. 16, 2005

(54) Process for preparing acrylic hotmelt PSAs

(75) Inventors: Marc Husemann, Hamburg (DE); Stephan Zoellner, Hamburg (DE)

Correspondence Address: Norris, McLaughlin & Marcus, P. A., 875 Third Avenue, 18th Floor, New York,, NY, 10022, US

(73) Assignee: tesa AG, Hamburg (DE)

(21) Appl. No.: 10/830,358

(22) Filed: Apr. 22, 2004

(30) Foreign Application Priority Data
Dec. 16, 2003 (DE) 103 59 349.7

(51) Int. Cl. B32B 7/12; B05D 5/10

(52) U.S. Cl. 428/343; 427/384

(57) ABSTRACT

The invention relates to a process for preparing acrylic hotmelt pressure-sensitive adhesives. Provision is made here for this process to comprise the steps of (a) providing a pressure-sensitive adhesive polyacrylate and a difunctional or polyfunctional reactive resin, the pressure-sensitive adhesive polyacrylate having at least one functional group which enables it to react with the difunctional or polyfunctional reactive resin; (b) preparing a mixture comprising the pressure-sensitive adhesive polyacrylate and the difunctional or polyfunctional reactive resin by mixing the pressure-sensitive adhesive polyacrylate in the melt with the difunctional or polyfunctional reactive resin; (c) coating the mixture onto a backing material; and (d) thermally curing the mixture on the backing material.

### The invention relates to a process for preparing acrylic hotmelt pressure-sensitive adhesives (PSAs) and to their use.

For industrial PSA tape applications it is very common to use polyacrylate PSAs. Polyacrylates possess a variety of advantages over other elastomers. They are highly stable to UV light, oxygen and ozone. Synthetic and natural rubber adhesives normally contain double bonds, which make these adhesives unstable to the aforementioned environmental effects. Another advantage of polyacrylates is their serviceability within a relatively wide temperature range.

Polyacrylate PSAs are generally prepared in solution by free radical polymerization. The polyacrylates are generally coated onto the corresponding backing material from solution, using a coating bar, and then dried. The polymer is crosslinked in order to increase the cohesion. Curing takes place thermally, by UV crosslinking or by EB curing (EB stands for electron beams). The process described is relatively costly and environmentally objectionable, since as a general rule the solvent is not recycled and the high consumption of organic solvents represents a high environmental burden.

Moreover, it is very difficult to produce PSA tapes with a high adhesive application rate without bubbles.

One remedy to these disadvantages is the hotmelt process. In this process, the PSA is applied to the backing material from the melt. However, this new technology is not without its limitations. Prior to coating, the solvent is removed from the PSA in a drying extruder. The drying process entails a relatively high temperature and shearing effect, so that high molecular mass polyacrylate PSAs in particular are severely damaged. The acrylic PSA undergoes gelling or the low molecular mass fraction is greatly enriched as a result of molecular weight breakdown. Both effects are unwanted, since they are disadvantageous for the application. Either the adhesive can no longer be applied or there are changes in its performance properties, since, for example, when a shearing force acts on the adhesive the low molecular mass fractions act as lubricants and so lead to premature failure of the adhesive.

A further disadvantage of acrylic hotmelt PSAs is the orientation which occurs after extrusion coating. During the coating operation the hotmelt adhesive is forced through a die and then stretched once again as it is transferred onto the backing material. In this way the polymer chains are oriented, before then moving back to the original state of disorder on the backing material (a basic thermodynamic principle). This is manifested visually in shrinkback of the PSA, which can be required in some cases but is unusual in comparison to conventional solvent coating (DE 100 34 069.5).

It is an object of the invention to eliminate the disadvantages of the prior art. The intention is in particular to specify a process for preparing acrylic hotmelt PSAs having high shear strength and high thermal stability. These acrylic hotmelt PSAs ought also to be suitable for producing high-shear-strength acrylic hotmelt PSA tapes having high thermal stability.

This object is achieved by the present invention as described hereinbelow.

The invention provides a process for preparing acrylic hotmelt PSAs which comprises the steps of
(a) providing a pressure-sensitively adhesive polyacrylate and a difunctional or polyfunctional reactive resin, the pressure-sensitively adhesive polyacrylate having at least one functional group which enables it to react with the difunctional or polyfunctional reactive resin;
(b) preparing a mixture comprising the pressure-sensitively adhesive polyacrylate and the difunctional or polyfunctional reactive resin by mixing the pressure-sensitively adhesive polyacrylate in the melt with the difunctional or polyfunctional reactive resin;
(c) coating the mixture onto a backing material; and
(d) thermally curing the mixture on the backing material.

Given an appropriate choice of backing material, the resultant acrylic hotmelt PSA can be used together with the backing material as an acrylic hotmelt PSA tape. This acrylic hotmelt PSA tape is highly shear-resistant and has a high thermal stability.

Advantageously the pressure-sensitively adhesive polyacrylate is mixed in the melt in a static mixing head with the difunctional or polyfunctional reactive resin.

The mixture is preferably coated onto the backing material using a die, a doctor blade or a roll mill.

To implement the process of the invention a first vessel is charged essentially with the reactive resin while a second vessel is charged essentially with the polyacrylate, the further formulating ingredients having already been admixed with these two components, if desired, in a standard mixing procedure.

The pressure-sensitively adhesive polyacrylate is also referred below as polyacrylate or polymer and the difunctional or polyfunctional reactive resin is also referred to below as reactive resin. Both the polyacrylate and the reactive resin are also referred to as component or components.

The term “pressure-sensitive adhesive” or “PSA” is used below synonymously with the term “acrylic hotmelt pressure-sensitive adhesive/PSA”. The acrylic hotmelt pressure-sensitive adhesive tape is also referred to as adhesive tape, pressure-sensitive adhesive tape or PSA tape.

The two components are mixed in a mixer of a multi-component mixing and metering unit. In order to maintain the stoichiometric proportions of the reactive components they are metered with automatic regulation via a flow meter.

The PSA thus mixed is applied to a backing material, which is preferably moving at constant speed. The applied PSA is passed through a heating tunnel, in which the PSA cures. The coatweight of the PSA is arbitrary, preference being given to coatweights of between 10 and 1000 g/m², more preferably between 25 and 200 g/m².

As compared with conventional solvent coating, this process allows PSAs with a high application rate to be prepared with particular preference, since in this case it is possible to avoid the formation of bubbles.

For the process of the invention it is preferred to use polyacrylates having a comonomer composition containing
(a1) 75 to 98% by weight of acrylic and/or methacrylic esters of the formula CH₂═CH(R₁)(COOR₂), where R₁ is H or CH₃ and R₂ is an alkyl chain having 1 to 20 carbon atoms;
(a2) 0 to 10% by weight of acrylic and/or methacrylic acid of the formula CH₂═CH(R₁)(COOH), where R₁ is H or CH₃;
(a3) 0 to 5% by weight of olefinically unsaturated monomers having UV-crosslinking functional groups;
(a4) 0 to 20% by weight of olefinically unsaturated monomers having functional groups capable of reaction with the reactive resins.

With particular preference the comonomer composition contains
(a1) 86 to 90% by weight of acrylic and/or methacrylic esters of the formula CH₂═CH(R₁)(COOR₂), where R₁ is H or CH₃ and R₂ is an alkyl chain having 1 to 20 carbon atoms;
(a2) 4 to 6% by weight of acrylic and/or methacrylic acid of the formula CH₂═CH(R₁)(COOH), where R₁ is H or CH₃;
(a3) 0.5 to 1.5% by weight of olefinically unsaturated monomers having UV-crosslinking functional groups; and
(a4) 0 to 20% by weight of olefinically unsaturated monomers having functional groups capable of reaction with the reactive resins.

The monomers of the comonomer composition are preferably chosen such that the resultant polymers can be used at room temperature as PSAs, especially such that the resultant polymers possess pressure-sensitive adhesion properties in accordance with the Handbook of Pressure Sensitive Adhesive Technology by Donatas Satas (van Nostrand, New York 1989).

In order to obtain a polymer glass transition temperature T_{g} preferable for PSAs, i.e. T_{g}≦25° C., and in accordance with the details given above, the monomers are very preferably selected, and the quantitative composition of the monomer mixture advantageously chosen, such that the desired T_{g} for the polymer results in accordance with the Fox equation (G1) (cf. T. G. Fox, Bull. Am. Phys. Soc. 1 (1956) 123):

$$\frac{1}{{T}_{g}} = {\sum }_{n} \frac{{w}_{n}}{{T}_{g , n}} \qquad ( G1 )$$

In this equation n represent the serial number of the monomers used, wₙ the mass fraction of the respective monomer n (percent by weight), and T_{g,n} the respective glass transition temperature of the homopolymer of the respective monomer n, in K.

In one very preferred form the monomers used for (a1) are acrylic or methacrylic monomers composed of acrylic and methacrylic esters having alkyl groups of 4 to 14 carbon atoms, preferably 4 to 9 carbon atoms. Specific examples, without wishing to be limited by this recitation, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate and the branched isomers thereof, such as isobutyl acrylate, 2-ethylhexyl acrylate, 2-ethylhexyl methacrylate, isooctyl acrylate and isooctyl methacrylate.

Further classes of compound to be used for (a1) are monofunctional acrylates and methacrylates of bridged cycloalkyl alcohols, composed of at least 6 carbon atoms. The cycloalkyl alcohols may also be substituted, by alkyl groups having 1 to 6 carbon atoms, halogen atoms or cyano groups, for example. Specific examples are cyclohexyl methacrylates, isobornyl acrylate, isobornyl methacrylates and 3,5-dimethyladamantyl acrylate.

In one very preferred embodiment monomers used for (a4) are monomers which carry polar groups such as carboxylic acid groups, acid anhydride groups, phosphonic acid groups, hydroxyl groups, amide, imide or amino groups, isocyanate groups, epoxy groups or thiol groups.

Examples of monomers for (a4) are N,N-dialkyl-substituted amides, such as N,N-dimethylacrylamide, N,N-dimethylmethacrylamide, N-tert-butylacrylamide, N-vinyl-pyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide and N-isopropylacrylamide, this recitation not being conclusive.

Further preferred examples for (a4) are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, glyceryl methacrylate, 6-hydroxyhexyl methacrylate, vinylacetic acid, β-acryloyloxypropionic acid, trichloroacrylic acid, fumaric acid, crotonic acid, aconitic acid, acrylonitrile and dimethylacrylic acid, this recitation not being conclusive.

Moreover, in a further embodiment, use is made for (a3) of photoinitiators having a copolymerizable double bond. Suitable photoinitiators are Norrish I and II photoinitiators. Examples are benzoic acrylate and acrylic benzophenon from UCB (Ebecryl P 36®). In principle it is possible to copolymerize all photoinitiators which are known to the person skilled in the art and are able to crosslink the polymer via a radical mechanism under UV irradiation. An overview of possible photoinitiators which can be used, and which can be functionalized with a double bond, is given in Fouassier: “Photoinitiation, Photopolymerization and Photocuring: Fundamentals and Applications”, Hanser-Verlag, München 1995. For further details refer to Carroy et al. in “Chemistry and Technology of UV and EB Formulation for Coatings, Inks and Paints”, Oldring (ed), 1994, SITA, London.

To prepare the PSAs is it advantageous to carry out conventional radical polymerizations or control radical polymerizations. For the polymerizations which proceed by a radical mechanism it is preferred to use initiator systems further comprising further radical initiators for the polymerization, especially thermally decomposing radical-forming azo or peroxo initiators. In principle, however, all customary initiators familiar to the person skilled in the art for acrylates are suitable. The production of C-centred radicals is described in Houben Weyl, Methoden der Organischen Chemie, Vol. E 19a, pp. 60-147. These methods are preferentially employed analogously.

Examples of radical sources are peroxides, hydroperoxides and azo compounds. Examples of typical radical initiators are potassium peroxodisulphate, dibenzoyl peroxide, cumene hydroperoxide, cyclohexanone peroxide, di-t-butyl peroxide, azodiisobutyronitrile, cyclohexylsulphonyl acetyl peroxide, diisopropyl percarbonate, t-butyl peroctoate and benzpinacol, the recitation not being conclusive. In one very preferred embodiment a radical initiator used is 1,1′-azobis(cyclohexanecarbonitrile) (Vazo 88™ from DuPont).

The average molecular weights Mₙ of the PSAs arising from the radical polymerization are very preferably chosen such that they are situated within a range from 20 000 to 500 000 g/mol; specifically for further use as acrylic hotmelt PSAs, PSAs are prepared having average molecular weights Mₙ of from 100 000 to 300 000 g/mol. The reduction in molecular weight lowers the flow viscosity, meaning that the mixing energy required is less.

The average molecular weight is determined by size exclusion chromatography (SEC) or matrix-assisted laser desorption/ionization mass spectrometry (MALDI-MS).

The polymerization can be conducted in bulk, in the presence of one or more organic solvents, in the presence of water or in mixtures of organic solvents and water. The aim is to minimize the amount of solvent used. Suitable organic solvents are pure alkanes (e.g. hexane, heptane, octane, isooctane), aromatic hydrocarbons (e.g. benzene, toluene, xylene), esters (e.g. ethyl, propyl, butyl or hexyl acetate), halogenated hydrocarbons (e.g. chlorobenzene), alkanols (e.g. methanol, ethanol, ethylene glycol, ethylene glycol monomethyl ether) and ethers (e.g. diethyl ether, dibutyl ether) or mixtures thereof. A water-miscible or hydrophilic cosolvent can be added to the aqueous polymerization reactions in order to ensure that in the course of monomer conversion the reaction mixture is present in the form of a homogeneous phase. Cosolvents which can be used with advantage for the present invention are selected from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulphides, sulphoxides, sulphones, alcohol derivatives, hydroxy ether derivatives, amino alcohols, ketones and the like, and also derivatives and mixtures thereof.

Depending on conversion and temperature the polymerization takes between 4 and 72 hours. The higher the reaction temperature can be chosen, i.e. the higher the thermal stability of the reaction mixture, the lower the reaction time that can be chosen.

In order to initiate the polymerization it is essential to introduce heat for the thermally decomposing initiators. For the thermally decomposing initiators the polymerization can be initiated by heating to from 50 to 160° C., depending on initiator type.

In an advantageous procedure radical stabilization is effected using nitroxides of type (NIT 1) or (NIT 2): 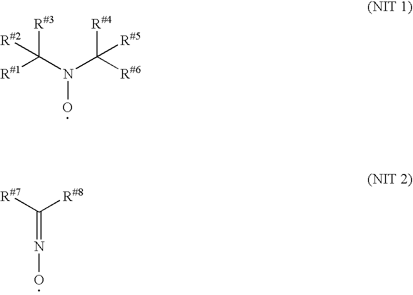
where R^{#1}, R^{#2}, R^{#3}, R^{#4}, R^{#5}, R^{#6}, R^{#7} and R^{#8} independently of one another denote the following compounds or atoms:
i) halides, such as chlorine, bromine or iodide, for example;
ii) linear, branched, cyclic and heterocyclic hydrocarbons having 1 to 20 carbon atoms, which can be saturated, unsaturated or aromatic;
iii) esters —COOR^{#9}, alkoxides —OR^{#10} and/or phosphonates —PO(OR^{#11})₂, where R^{#}9, R^{#10} and/or R^{#11} stand for radicals from group ii).

Compounds of the structure (NIT 1) or (NIT 2) can also be attached to polymer chains of whatever kind (in which case it is preferred for at least one of the abovementioned radicals to represent such a polymer chain) and can therefore be utilized, for the synthesis of block copolymers as macro radicals or macroregulators.

Of greater preference as controlled regulators for the polymerization are compounds of the following type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphtyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods by which the PSAs can be prepared alternatively may be selected from the state of the art:

U.S. Pat. No. 4,581,429 A discloses a controlled-growth radical polymerization process which uses as initiator a compound of the formula R′R″N—O—Y, in which Y is a free radical species which is able to polymerize unsaturated monomers. The reactions, however, generally have low conversions. A particular problem is the polymerization of acrylates, which runs only to very low yields and molar masses. WO 98/13392 A1 described open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific radical compounds, such as phosphorus-containing nitroxides, for example, based on imidazolidine, are used. WO 98/44008 A1 discloses specific nitroxyls based on morpholines, piperazinons and piperazindions. DE 199 49 352 A1 discloses heterocyclic alkoxyamines as regulator in controlled-growth radical polymerizations. Corresponding further developments of the alkoxyamines or of the corresponding free nitroxides improve the efficiency for the preparation of polyacrylates (Hawker, paper at the National Meeting of the American Chemical Society, Spring 1997; Husemann, paper to the IUPAC World-Polymer Meeting 1998, Gold Coast).

Another controlled polymerization method which can be used advantageously to synthesize block copolymers is atom transfer radical polymerization (ATRP), in which the initiator used preferably comprises monofunctional or difunctional secondary or tertiary halides and, to abstract the halide(s), complexes of Cu, Ni, Fe, Pd, Pt, Ru, Os, Rh, Co, Ir, Ag or Au (EP 0824 111 A1; EP 826 698 A1; EP 824 110 A1; EP 841 346 A1; EP 850 957 A1). The different possibilities of ATRP are described further in U.S. Pat. No. 5,945,491 A, U.S. Pat. No. 5,854,364 A and U.S. Pat. No. 5,789,487 A.

With further advantage the polymer used in accordance with the invention can be prepared via an ionic polymerization. In this case the reaction medium used preferably comprises inert solvents, such as aliphatic and cycloaliphatic hydrocarbons, for example, or else aromatic hydrocarbons.

The living polymer is generally represented by the structure P_{L}(A)-Me, where Me is a metal from group I of the Periodic Table, such as lithium, sodium or potassium, and P_{L}(A) is a growing polymer block of the monomers [(a1) to (a4)]. The molar mass of the polymer under preparation is determined by the ratio of initiator concentration to monomer concentration.

Examples of suitable polymerization initiators include n-propyllithium, n-butyllithium, sec-butyllithium, 2-naphthyllithium, cyclohexyllithium and octyllithium, this recitation making no claim to completeness. Additionally, initiators based on samarium complexes are known for the polymerization of acrylates (Macromolecules, 1995, 28, 7886) and can be employed here.

It is also possible, moreover, to use difunctional initiators, such as 1,1,4,4-tetraphenyl-1,4-dilithiobutane or 1,1,4,4-tetraphenyl-1,4-dilithioisobutane, for example. Coinitiators may likewise be employed. Suitable coinitiators include lithium halides, alkali metal alkoxides or alkylaluminium compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

A very preferred preparation process conducted is a variant of the RAFT (reversible addition-fragmentation chain transfer) polymerisation. The polymerization process is described in detail in, for example, publications WO 98/01478 A1 and WO 99/31144 A1. Suitable with particular advantage for the preparation are trithiocarbonates of the general structure R′″—S—C(S)—S—R′″ (Macromolecules 2000, 33, 243-245).

In one very advantageous version, for example, the trithiocarbonates (TTC1) and (TTC2) or the thio compounds (THI1) and (THI2) are used for the polymerization, it being possible for Φ to be a phenyl ring, which can be unfunctionalized or functionalized by alkyl or aryl substitutes attached directly or via ester or ether bridges, or to be a cyano group, or to be a saturated or unsaturated aliphatic radical. The phenyl ring Φ may optionally carry one or more polymer blocks, examples being polybutadiene, polyisoprene, polychloroprene or poly(meth)acrylate, which can be constructed in accordance with the definition of the pressure-sensitively adhesive polyacrylate, or may carry polystyrene, to name but a few. Functionalizations may be, for example, halogens, hydroxyl groups, epoxide groups, groups containing nitrogen or sulphur, without this list making any claim to completeness.

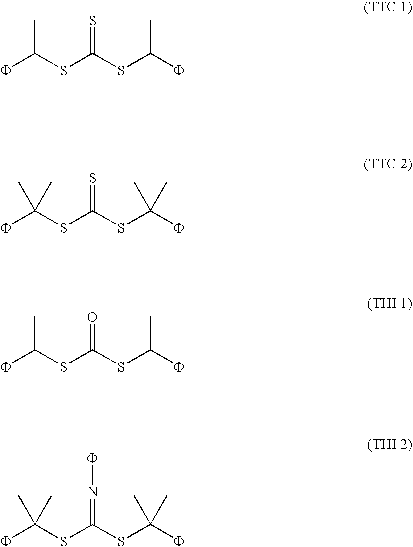

It is also possible to employ thioesters of the general structure
R^{$1}—C(S)—S—R^{$2} (THE)
particularly in order to prepare asymmetric systems. R^{$1} and R^{$2} can be chosen independently of one another, it being possible for R^{$1} to be a radical from one of the following groups i) to iv) and R^{$2} to be a radical from one of the following groups i) to iii):
i) C₁ to C₁₈ alkyl, C₂ to C₁₈ alkenyl, C₂ to C₁₈ alkynyl, each linear or branched; aryl, phenyl, benzyl, aliphatic and aromatic heterocycles;
ii) —NH₂, —NH—R^{$3}, —NR^{$3}R^{$4}, —NH—C(O)—R^{$3}, —NR^{$3}—C(O)—R^{$4}, —NH—C(S)—R^{$3}, —NR^{$3}—C(S)—R^{$4}, 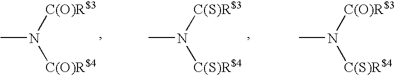
   where R^{$3} and R^{$4} are radicals chosen independently of one another from group i);
iii) —S—R^{$5}, —S—C(S)—R^{$5}, it being possible for R^{$5} to be a radical from one of groups i) and ii);
iv) —O—R^{$6}, —O—C(O)—R^{$6}, it being possible for R^{$6} to be a radical from one of groups i) and ii).

In conjunction with the abovementioned controlled-growth radical polymerizations it is preferred to use initiator systems further comprising additional radical initiators for the polymerization, especially thermally decomposing radical-forming azo or peroxo initiators. In principle, however, all customary initiators known for acrylates are suitable for this purpose. The production of C-centered radicals is described in Houben-Weyl, Methoden der Organischen Chemie, Vol. E19a, p. 60ff. These methods are employed preferentially. Examples of radical sources are peroxides, hydroperoxides and azo compounds. A number of non-exclusive examples of typical radical initiators that may be mentioned here include potassium peroxodisulphate, dibenzoyl peroxide, cumene hydroperoxide, cyclohexanone peroxide, cyclohexylsulphonyl acetyl peroxide, di-tert-butyl peroxide, azodiisobutyronitrile, diisopropyl percarbonate, tert-butyl peroctoate and benzpinacol. In one very preferred variant the radical initiator used is 1,1′-azobis(cyclohexanenitrile) (Vazo 88®, DuPont®) or 2,2-azobis(2-methylbutanenitrile) (Vazo 67®, DuPont®). In addition it is also possible to use radical sources which release radicals only under UV irradiation.

In the conventional RAFT process polymerization is generally carried out only to low conversions (WO 98/01478 A1) in order to produce molecular weight distributions which are as narrow as possible. As a result of the low conversions, however, these polymers cannot be used as PSAs and in particular not as hotmelt PSAs, since the high fraction of residue monomers adversely affects the technical adhesive properties, the residue monomers contaminate the solvent recyclate in the concentration process, and the corresponding self-adhesive tapes would exhibit a very high level of outgassing.

As reactive resins it is possible in principle to use any resins containing at least two functional groups capable of reaction with the polyacrylate.

One very preferred group comprises epoxy resins. The molecular weight of the epoxy resins varies from 100 g/mol up to a maximum of 10000 g/mol for polymeric epoxy resins.

The epoxy resins include, for example, the reaction product of bisphenol A and epichlorohydrin, the reaction product of phenol and formaldehyde (novolak resins) and epichlorohydrin, glycidyl esters, and the reaction product of epichlorohydrin and p-aminophenol.

Preferred commercial examples include Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical, and HPT™ 1071 and HPT™ 1079, likewise from Shell Chemical.

Examples of commercial aliphatic epoxy resins include vinylcyclohexane dioxides, such as ERL-4206, ERL-4221, ERL 4201, ERL-4289 or ERL-0400 from Union Carbide Corp.

Examples of novolak resins which can be employed include Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNippon Ink Chemistry or Epicote™ 152 from Shell Chemical.

As reactive resins it is also possible to employ melamine resins, such as Cymel™ 327 and 323 from Cytec.

As reactive resins it is also possible to use terpene-phenolic resins, such as NIREZ™ 2019 from Arizona Chemical.

As reactive resins it is also possible to use phenolic resins, such as YP 50 from Toto Kasei, PKHC from Union Carbide Corp. and BKR 2620 from Showa Union Gosei Corp.

As reactive resins it is also possible to use polyisocyanates, such as Coronate™ L from Nippon Polyurethane Ind. and Desmodur™ N3300 or Mondur™ 489 from Bayer.

In order to accelerate the reaction between the two components it is possible to add crosslinkers and accelerators to the mixture.

Examples of suitable accelerators include imidazoles, available commercially as 2M7, 2E4MN, 2PZ-CN, 2PZ-CNS, P0505, L07N from Shikoku Chem. Corp. or Curezol 2MZ from Air Products.

It is additionally possible to use amines, especially tertiary amines, for acceleration.

In one possible embodiment the pressure-sensitive adhesive comprises further formulating ingredients, such as, for example, fillers, pigments, Theological additives, additives for improving adhesion, plasticizers, resins, elastomers, ageing inhibitors (antioxidants), light stabilizers, UV absorbers and other auxiliaries and additives, such as dryers (for example molecular sieve zeolites, calcium oxide), flow and levelling agents, wetting agents (surfactants) or catalysts, for example.

As fillers it is possible to employ any finely ground solid additives such as, for example, chalk, magnesium carbonate, zinc carbonate, kaolin, barium sulphate, titanium dioxide or calcium oxide. Further examples are talc, mica, silica, silicates or zinc oxide. Mixtures of the substances stated may also be used.

The pigments used may be organic or inorganic in nature. All kinds of organic and inorganic colour pigments are suitable, examples being white pigments such as titanium dioxide, for instance, for enhancing the light stability and UV stability, and also metal pigments.

Examples of rheological additives are pyrogenic silicas, phyllo silicates (bentonites), high molecular mass polyamide powders or castor oil derivative powders.

Additives for improving the adhesion may be, for example, substances from the groups of the polyamides or silanes.

Examples of plasticizers are phthalates, trimellites, phosphates, ester of adipic acid, and other acyclic dicarboxylic esters, fatty acid esters, hydroxycarboxylic esters, alkylsulphonic esters of phenol, aliphatic, cycloaliphatic and aromatic mineral oils, hydrocarbons, liquid or semisolid rubbers (for example nitrile or polyisoprene rubbers), liquid or semisolid polymers of butene and/or isobutene, acrylates, polyvinyl ethers, liquid resins and soft resins based on the raw materials which also constitute the basis of tackifer resins, wool wax and other waxes, silicones, and polymer plasticizers such as polyesters or polyurethanes, for instance.

Suitable resins are all natural and synthetic resins, such as rosin derivatives (derivatives formed for example by disproportionation, hydrogenation or esterification), coumarone-indene resins and polyterpene resins, aliphatic or aromatic hydrocarbon resins (C-5-, C-9-and (C-5)₂ resins), mixed C-5/C-9 resins, fully and partly hydrogenated derivatives of the type stated, resins of styrene or α-methylstyrene, and also terpene-phenolic resins and others as listed in Ullmanns Enzyklopädie der technischen Chemie (4th ed.), Volume 12, p. 525-555, Weinheim.

Examples of suitable elastomers include EPDM rubber or EPM rubber, polyisobutylene, butyl rubber, ethylene-vinyl acetate, hydrogenated block copolymers of dienes (for example, by hydrogenation of SBR, cSBR, BAN, NBR, SBS, SIS or IR; such polymers are known, for example, as SEPS and SEBS).

Furthermore, the PSAs of the invention can also, optionally, have UV photoinitiators added to them. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulphonyl chlorides, such as 2-naphthylsulphonyl chloride, and photoactive oximes, such as 1-phenyl-1,2-propanedione 2-(O-ethoxycarbonyl) oxime, for example.

The photoinitiators mentioned above and others which can be used, and others of the Norrish I or Norrish II type, may contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholinyl ketone, aminoketone, azobenzoin, thioxanthone, hexaarylbisimidazole, triazine, or fluorenone radicals, it being possible for each of these radicals to be additionally substituted by one or more halogen atoms and/or one or more alkoxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. For further details, Carroy et al. in “Chemistry and Technology of UV and EB Formulation for Coatings, Inks and Paints”, Oldring (Ed.), 1994, SITA, London, can be consulted.

The functionalities of the interacting components must be selected such that at least one of the two components has a functionality of more than two, so that crosslinking and/or chain extension can take place.

The adhesives can be applied directly, in an indirect transfer process, by coextrusion with the backing, from solution, dispersion or the melt. One particularly preferred form of application is that of coating onto a release paper or in-process liner.

In this case coating in the desired coat thickness is carried out with the as yet uncured, pastelike or liquid adhesive, with the assistance of 2-component mixing technology.

Subsequently the PSA is cured and/or crosslinked as it passes through a drying tunnel at a temperature between room temperature and 130° C., depending on the chosen formulation, functional groups and, where appropriate, the accelerator or quantity of catalyst.

In principle it is also possible to crosslink the PSAs additionally using electron beams. Typical irradiation apparatus which may be employed includes linear cathode systems, scanner systems and segmented cathode systems, where the equipment in question comprises electron beam accelerators. A detailed description of the state of the art and the most important process parameters can be found in Skelhorne, Electron Beam Processing, in Chemistry and Technology of UV and EB formulation for Coatings, Inks and Paints, Vol. 1, 1991, SITA, London. The typical acceleration voltages are in the range between 50 kV and 500 kV, preferably between 80 kV and 300 kV. The scatter doses employed range between 5 to 150 kGy, in particular between 20 and 100 kGy.

Optional UV crosslinking is carried out by means of irradiation with short-wave ultraviolet radiation in a wavelength range from 200 to 400 nm, depending on UV photoinitiator used, particularly using high-pressure or medium-pressure mercury lamps with an output of from 80 to 240 W/cm. The intensity of irradiation is adapted to the particular quantum yield of the UV photoinitiator and the degree of crosslinking that is to be established.

The transfer adhesive tape thus produced can be wound up in this form or laminated onto a backing material.

Backing materials used for the adhesive, for adhesive tapes for example, are the customary materials which are familiar to those skilled in the art, such as films (polyester, PET, PE, PP, BOPP, PVC, polyimide), nonwovens, foams, wovens and woven films, and metal foils.

Single- or double-sided adhesive tapes can be produced in this way.

The process of the invention is illustrated below with reference to examples.

### EXAMPLE

Test Methods

180° Bond Strength Test (Test A)

A 20 mm wide strip of an adhesive tape consisting of an acrylic PSA applied as a film to polyester was applied to a steel plate. The strip was pressed onto the substrate twice using a 2 kg weight. Immediately thereafter the adhesive tape was peeled from the substrate at 300 mm/min and at an angle of 180°. The steel plate was washed twice with acetone and once with isopropanol. The results are reported in N/cm and are averaged from three measurements. All measurements were conducted at room temperature.

Shear Strength (Test B)

A 13 mm wide strip of the adhesive tape was applied to a smooth steel surface which had been cleaned three times with acetone and once with isopropanol. The area of application was 20 mm*13 mm (length*width). Subsequently the adhesive tape was pressed onto the steel substrate four times, applying a pressure of 2 kg. At room temperature a 1 kg weight was fastened to the adhesive tape. The shear stability times measured are expressed in minutes and correspond to the average from three measurements. Adhesive tapes having a shear strength of more than 250 minutes can be employed in the art.

Gel Permeation Chromatography GPC (Test C)

The average molecular weight M_{w} and the polydispersity PD were determined by the company Polymer Standards Service, Mainz, Del. The eluent used was THF containing 0.1% by volume trifluoroacetic acid. Measurement was made at 25° C. The preliminary column used was PSS-SDV, 5μ, 10³ Å, ID 8.0 mm×50 mm. Separation was carried out using the columns PSS-SDV, 5μ, 10³ and 10⁵ and 10⁶, each of ID 8.0 mm×300 mm. The sample concentration was 4 g/l, the flow rate 1.0 ml per minute. Measurement was carried out against PMMA standards.

### Preparation of nitroxide Ia (2,2,5-trimethyl-4-phenyl-3-azahexane -3-nitroxide)

The procedure was as per the experimental instructions from Journal of American Chemical Society, 121, 16, 3904-3920, 1999.

### Preparation of Alkoxyamines IIa (2,2,5-trimethyl-3-(1-phenylethoxy)-4-phenyl-3-aza-hexane)

The procedure was as per the experimental instructions from Journal of American Chemical Society, 121, 16, 3904-3920, 1999.

General Implementation of Nitroxide-Controlled Polymerizations:

A mixture of the alkoxyamine IIa, the nitroxide la (5 mol % based on alkoxyamine IIa), and 2.5 mol % Vazo 88™ (2.5 mol % based on alkoxyamine IIa) is mixed with the monomer (85% strength solution in xylene) and the mixture is degassed a number of times and then heated at 125° C. under an argon atmosphere. The reaction time is 24 h. The molecular weight and polydispersity were determined by GPC.

Preparation of the Polyacrylates

Polyacrylate 1:

28 g of acrylic acid, 292 g of 2-ethylhexyl acrylate and 40 g of methyl acrylate were used. As initiators and regulators, 325 mg of alkoxyamine (IIa), 11 mg of nitroxide (Ia) and 12 mg of Vazo 88™ (DuPont) were admixed. The polymerization was carried out in accordance with the general instructions for nitroxide-controlled polymerizations.

Polyacrylate 2:

28 g of acrylic acid, 20 g of methyl acrylate, 20 g of styrene and 332 g of 2-ethylhexyl acrylate were used. As initiators and regulators, 325 mg of alkoxyamine (IIa), 11 mg of nitroxide (Ia) and 12 mg of Vazo 88™ (DuPont) were admixed. The polymerization was carried out in accordance with the general instructions for nitroxide-controlled polymerizations.

Polyacrylate 3:

40 g of hydroxyethyl acrylate, 80 g of methyl acrylate and 280 g of 2-ethylhexyl acrylate were used. As initiators and regulators, 325 mg of alkoxyamine (IIa), 11 mg of nitroxide (Ia) and 12 mg of Vazo 88™ (DuPont) were admixed. The polymerization was carried out in accordance with the general instructions for nitroxide-controlled polymerizations.

Production of the Adhesive Layers

For the stated examples the coating operations were carried out on a laboratory coating unit from Pagendarm. The web width was 50 cm. The coating slot width was variably adjustable between 0 and 1 cm. The length of the heating tunnel was approximately 20 m. The temperature in the heating tunnel was divisible into four zones each freely selectable between room temperature and 120° C.

A multi-component mixing and metering unit from Spritztechnik-EMC was used. The mixing system was dynamic. The mixing head was designed for two liquid components and one gaseous component. The mixing rotor had a variable speed which went up to a maximum of approximately 5,000 rpm. The metering pumps of this unit were gear pumps having a capacity of max. 2 I/min approximately.

The two components are introduced into the mixing unit in the heated state, in order to lower the flow viscosity of the resin or resins and of the polyacrylate.

Depicted below are 5 formulations for preparing PSAs by the process of the invention, each component being followed by the mass thereof introduced into the mixer.

Rütapox™ 161: epoxy resin from Bakelite AG based on bisphenol A

Desmodur™ L75: polyfunctional isocyanate from Bayer AG

### Example 1

| | |
|---|---|
| Polyacrylate 1 | 10.0 kg |
| Rütapox ™ 161 | 1.2 kg |

### Example 2

| | |
|---|---|
| Polyacrylate 2 | 10.0 kg |
| Rütapox ™ 161 | 1.2 kg |

### Example 3

| | |
|---|---|
| Polyacrylate 3 | 10.0 kg |
| Desmodur ™ L75 | 0.3 kg |

### Example 4

| | |
|---|---|
| Polyacrylate 1 | 10.0 kg |
| Rütapox ™ 161 | 0.6 kg |

### Example 5

| | |
|---|---|
| Polyacrylate 2 | 10.0 kg |
| Rütapox ™ 161 | 0.6 kg |

General Production Process for PSA Tapes

After the resin has been metered in, on a standard commercial coating unit, the polyacrylates (1 to 3) are spread out onto standard commercial paper, siliconized on both sides, to form a web 50 μm thick and in the subsequent passage through the drying tunnel are crosslinked to form a PSA at a temperature from room temperature up to 140° C. with a residence time of from 10 to 30 minutes.

Results

The polyacrylates prepared by the process of the invention described above were tested as PSAs made by determining the shear strength of examples 1 to 5 and measuring the bond strength. The measurement procedures were in accordance with test methods A and B. The results are summarized in table 1 below.

TABLE 1

| | Test method A | Test method B |
|---|---|---|
| | Bond strength, steel | Shear strength |
| Example | (N/cm) | (min) |
| 1 | 3.2 | +10000 |
| 2 | 3.0 | +10000 |
| 3 | 4.1 | 1250 |
| 4 | 4.0 | 480 |
| 5 | 3.7 | 895 |

The result “+10000” is intended to express the fact that after 10000 minutes the test was terminated.

The results demonstrate that the examples produced in accordance with the process of the invention possess pressure-sensitive adhesion properties.

It should be understood that the preceding is merely a detailed description of one preferred embodiment or of a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

1. Process for preparing acrylic hotmelt pressure-sensitive adhesives which comprises the steps of:
(a) providing a pressure-sensitive adhesive polyacrylate and a difunctional or polyfunctional reactive resin, the pressure-sensitive adhesive polyacrylate having at least one functional group which enables it to react with the difunctional or polyfunctional reactive resin;
(b) preparing a mixture comprising the pressure-sensitive adhesive polyacrylate and the difunctional or polyfunctional reactive resin by mixing the pressure-sensitive adhesive polyacrylate in the melt with the difunctional or polyfunctional reactive resin;
(c) coating the mixture onto a backing material; and
(d) thermally curing the mixture on the backing material.

2. Process according to claim 1, wherein the pressure-sensitive adhesive polyacrylate is formed from a comonomer composition comprising:
(a1) 75 to 98% by weight of acrylic and/or methacrylic esters of the formula CH₂═CH(R₁)(COOR₂), where R₁ is H or CH₃ and R₂ is an alkyl chain having 1 to 20 carbon atoms;
(a2) 0 to 10% by weight of acrylic and/or methacrylic acid of the formula CH₂═CH(R₁)(COOH), where R₁ is H or CH₃;
(a3) 0 to 5% by weight of olefinically unsaturated monomers having UV-crosslinking functional groups;
(a4) 0 to 20% by weight of olefinically unsaturated monomers having functional groups capable of reaction with the reactive resins.

3. Process according to claim 1, wherein the pressure-sensitive adhesive polyacrylate is formed from a comonomer composition comprising:
(a1) 86 to 90% by weight of acrylic and/or methacrylic esters of the formula CH₂═CH(R₁)(COOR₂), where R₁ is H or CH₃ and R₂ is an alkyl chain having 1 to 20 carbon atoms;
(a2) 4 to 6% by weight of acrylic and/or methacrylic acid of the formula CH₂═CH(R₁)(COOH), where R₁ is H or CH₃;
(a3) 0.5 to 1.5% by weight of olefinically unsaturated monomers having UV-crosslinking functional groups; and
(a4) 0 to 20% by weight of olefinically unsaturated monomers having functional groups capable of reaction with the reactive resins.

4. Process according to claim 1, wherein the difunctional or polyfunctional reactive resin is selected from the group consisting of epoxy resins, novolak resins, melamine resins, terpene-phenolic resins, phenolic resins and polyisocyanates.

5. Process according to claim 1, wherein step (b) is performed in a static mixing head of a mixer.

6. Process according to claim 1, wherein the mixture in step (c) is coated onto the backing material via a die, a doctor blade or a roll mill.

7. Process according to claim 1, wherein the backing material is moving at a constant speed while being coated with the mixture.

8. Process according to claim 1, wherein the backing material coated with the mixture is passed through a heating tunnel for thermal curing.

9. An adhesive tape comprising an acrylic hotmelt pressure-sensitive adhesive prepared according to claim 1.

10. A method comprising adhering an adhesive tape to a substrate, wherein the adhesive tape is the adhesive tape according to claim 9.
